(19) United States
(12) Patent Application Publication
(10) Pub. No.: US 2026/0169021 A1
(43) Pub. Date: Jun. 18, 2026

(54) METHOD AND APPARATUS FOR DETECTING ACID ETCHING SPEED OF CORE GLASS

(71) Applicants: CHINA BUILDING MATERIALS ACADEMY CO., LTD., Beijing (CN); China National Building Material Group Co., Ltd., Beijing (CN)

(72) Inventors: Ran Zhao, Beijing (CN); Yan Duan, Beijing (CN); Peng Jiao, Beijing (CN); Jing Ma, Beijing (CN); Rui Zhang, Beijing (CN); Danqi Zhao, Beijing (CN); Yuwen Xing, Beijing (CN); Bo Liu, Beijing (CN); Jinkai Zhao, Beijing (CN)

(73) Assignees: CHINA BUILDING MATERIALS ACADEMY CO., LTD., Beijing (CN); China National Building Material Group Co., Ltd., Beijing (CN)

(21) Appl. No.: 19/306,478

(22) Filed: Aug. 21, 2025

(30) Foreign Application Priority Data
Dec. 16, 2024 (CN) 2024118517001

(51) Int. Cl. G01P 3/38; C03C 15/00

(52) U.S. Cl. CPC G01P 3/38; C03C 15/00

(57) ABSTRACT

A method for detecting an acid-etching speed of core glass includes obtaining an initial end-face image and an acid-etched end-face image sequence corresponding to a sample microchannel plate blank, selecting a plurality of target microholes in the initial end-face image and intercepting a microhole acid-etching image sequence corresponding to each target microhole from the plurality of acid-etched end-face images according to position coordinates of each target microhole; determining a plurality of total optical flow motion fields corresponding to each target microhole based on a preset optical flow algorithm and the plurality of microhole acid-etching images corresponding to each target microhole, determining a maximum motion speed value among the plurality of total optical flow motion fields as a target motion speed value corresponding to the sample microchannel plate blank, and determining an acid-etching speed of core glass corresponding to the sample microchannel plate blank.

### TECHNICAL FIELD

The present application relates to the technical field of microchannel plate performance detection, and particularly to a method and apparatus for detecting the acid-etching speed of core glass.

### BACKGROUND ART

A microchannel plate is an electron multiplication device composed of tens of millions of microchannels with inner diameters of 5-7 micrometers. It offers advantages such as small size, light mass, high resolution, high gain, low noise, and low operating voltage. When an electron enters a microchannel within the microchannel plate, it collides with the inner wall of the microhole and multiplies into hundreds of thousands of electrons, which are emitted from the opposite end of the microhole. This characteristic makes the microchannel plate a core component for photoelectric multiplication in devices such as low-light-level night vision devices and medical imaging instruments.

The preparation process of a microchannel plate is relatively complex: First, a clad glass tube and a core glass rod made of two different glass materials are nested together and drawn into micron-level filaments. Second, a large number of micron-level filaments are provided in an array and then hot-pressed to synthesize a rod bundle composed of a plurality of filaments. Third, the rod bundle is cut into slices with a thickness of approximately 0.8 mm to obtain a microchannel plate blank. Then, the microchannel plate blank is immersed in an acid solution. Due to the fact that the core glass is extremely susceptible to corrosion by the acid solution, while the clad glass has strong resistance to the acid solution, the acid solution is able to corrode away the core glass in the microchannel plate blank, while the clad glass is retained, thereby forming a large number of microholes. Finally, the corroded microchannel plate blank is subjected to hydrogen reduction, cold and hot processing and other operations to prepare the finished product of microchannel plate.

The electron-multiplying function of a microchannel plate resides in the clad glass of each microhole. Therefore, to achieve the best electron-multiplying effect, the core glass must be completely etched away during fabrication, while the clad glass must be fully preserved. However, although the clad glass exhibits strong resistance to the acid solution, prolonged immersion of the microchannel plate blank in the acid solution will still erode part of the clad glass. Therefore, when producing the finished product of microchannel plate from a plurality of microchannel plate blanks, it is necessary to first select sample microchannel plate blanks from the plurality of microchannel plate blanks and measure the acid-etching speed of the sample microchannel plate blanks (i.e., the corrosion speed of the core glass by the acid solution). In the subsequent fabrication process of the finished products of microchannel plate, the immersion time of each microchannel plate blank in the acid solution is determined based on the acid-etching speed corresponding to the sample microchannel plate blanks.

At present, the weighing method is commonly used to detect the acid-etching speed of sample microchannel plate blanks. Specifically, the mass of a sample microchannel plate blank is first measured with an electronic balance. The sample microchannel plate blank is then immersed in an acid solution for a preset duration, after the sample microchannel plate blank is removed, the sample microchannel plate blank is reweighed with the electronic balance. Finally, the acid-etching speed of the sample microchannel plate blank is calculated based on the two measured masses, the preset duration, and the end-face area of the sample microchannel plate blank. However, when the electronic balance has low measurement accuracy or the detection personnel lacks work experience and operates improperly, the mass of the sample microchannel plate blank is not able to be accurately measured, which may lead to inaccurate detection of the acid-etching speed of the sample microchannel plate blank.

### SUMMARY

Embodiments of the present application provide a method and apparatus for detecting the acid-etching speed of core glass, primarily aimed at improving the accuracy of detecting the acid-etching speed of sample microchannel plate blanks.

To solve the above technical problem, embodiments of the present application provide the following technical solutions:

In a first aspect, the present application provides a method for detecting an acid-etching speed of core glass, the method including:
Obtaining an initial end-face image and an acid-etched end-face image sequence corresponding to a sample microchannel plate blank, wherein the initial end-face image is an image obtained by photographing a target area of the sample microchannel plate blank with a photographing device before acid-etching the target area with an acid solution, the acid-etched end-face image sequence includes a plurality of acid-etched end-face images, and the plurality of acid-etched end-face images are a plurality of consecutively photographed images obtained by photographing the target area with the photographing device after acid-etching the target area with the acid solution;
Selecting a plurality of target microholes in the initial end-face image, and intercepting microhole acid-etching image sequences corresponding to each of the target microholes from the plurality of acid-etched end-face images according to the position coordinates of each of the target microholes, wherein the position coordinates of the target microholes indicate the positions of the target microholes in the initial end-face image, and the microhole acid-etching image sequences corresponding to the target microholes include a plurality of microhole acid-etching images of the target microholes;
Determining a plurality of total optical flow motion fields corresponding to each of the target microholes based on a preset optical flow algorithm and the plurality of microhole acid-etching images corresponding to each of the target microholes;
Determining a maximum motion speed value among the plurality of total optical flow motion fields as a target motion speed value corresponding to the sample microchannel plate blank; and
Determining the acid-etching speed of core glass of the sample microchannel plate blank according to the target motion speed value and a preset data table, wherein the preset data table includes a plurality of preset motion speed intervals and the acid-etching speed of core glass corresponding to each of the preset motion speed intervals.

In a second aspect, the present application further provides an apparatus for detecting an acid-etching speed of core glass, the apparatus including:
An acquisition unit, configured to obtain an initial end-face image and an acid-etched end-face image sequence corresponding to a sample microchannel plate blank, wherein the initial end-face image is an image obtained by photographing a target area of the sample microchannel plate blank with a photographing device before acid-etching the target area with an acid solution, the acid-etched end-face image sequence includes a plurality of acid-etched end-face images, and the plurality of acid-etched end-face images are a plurality of consecutively photographed images obtained by photographing the target area with the photographing device after acid-etching the target area with the acid solution;
An interception unit, configured to select a plurality of target microholes in the initial end-face image, and intercepting microhole acid-etching image sequences corresponding to each of the target microholes from the plurality of acid-etched end-face images according to the position coordinates of each of the target microholes, wherein the position coordinates of the target microholes indicate the positions of the target microholes in the initial end-face image, and the microhole acid-etching image sequences corresponding to the target microholes include a plurality of microhole acid-etching images of the target microholes;
A first determination unit, configured to determine a plurality of total optical flow motion fields corresponding to each of the target microholes based on a preset optical flow algorithm and the plurality of microhole acid-etching images corresponding to each of the target microholes;
A second determination unit, configured to determine a maximum motion speed value among the plurality of total optical flow motion fields as a target motion speed value corresponding to the sample microchannel plate blank; and
A third determination unit, configured to determine the acid-etching speed of core glass of the sample microchannel plate blank according to the target motion speed value and a preset data table, wherein the preset data table includes a plurality of preset motion speed intervals and the acid-etching speed of core glass corresponding to each of the preset motion speed intervals.

In a third aspect, an embodiment of the present application provides a storage medium, the storage medium including a stored program, wherein when the program is run, it controls the apparatus on which the storage medium is located to execute the method for detecting the acid-etching speed of core glass according to the first aspect.

In a fourth aspect, an embodiment of the present application provides a device for detecting the acid-etching speed of core glass, the device including a storage medium; and one or more processors, wherein the storage medium is coupled to the processors, and the processors are configured to execute program instructions stored in the storage medium; when the program instructions run, the method for detecting the acid-etching speed of core glass according to the first aspect is executed.

By means of the above technical solutions, the technical solutions provided by the present application have at least the following advantages:
The present application provides a method and apparatus for detecting an acid-etching speed of core glass. In the present application, after a detection worker captures an initial end-face image and a plurality of acid-etched end-face images corresponding to a sample microchannel plate blank through an imaging device, and stores the initial end-face image and the plurality of acid-etched end-face images corresponding to the sample microchannel plate blank in a local storage space of a target terminal device, an acid-etching speed detection application program acquires, from the local storage space of the target terminal device, the initial end-face image and the plurality of acid-etched end-face images corresponding to the sample microchannel plate blank, and randomly selects N acid-etched end-face images with consecutive shooting sequences from the plurality of acid-etched end-face images to form an acid-etched end-face image sequence corresponding to the sample microchannel plate blank. Next, the acid-etching speed detection application program selects a plurality of target microholes in the initial end-face image, intercepts, according to the position coordinates corresponding to each target microhole, a microhole acid-etching image sequence corresponding to each target microhole from the plurality of acid-etched end-face images, determines, based on a preset optical flow algorithm and the plurality of microhole acid-etching images included in the microchannel acid-etching image sequence corresponding to each target microhole, a plurality of total optical flow motion fields corresponding to each target microhole, determines a maximum motion velocity value among the plurality of total optical flow motion fields as a target motion velocity value corresponding to the sample microchannel plate blank, and determines the acid-etching speed of core glass corresponding to the sample microchannel plate blank according to the target motion velocity value corresponding to the sample microchannel plate blank and a preset data table. Because in the present application, only the detection worker needs to capture, through an imaging device, the initial end-face image and the plurality of acid-etched end-face images corresponding to the sample microchannel plate blank, and the acid-etching speed detection application program is able to determine the acid-etching speed of core glass corresponding to the sample microchannel plate blank. The entire process does not require intervention by the detection worker and does not involve the use of an electronic balance, thereby ensuring the accuracy of detecting the acid-etching speed of the sample microchannel plate blank.

The above description merely outlines the technical solutions of the present application. To understand the technical means of the present application more clearly and implement them in accordance with the content of the specification, and to make the above and other objects, features, and advantages of the present application more apparent and understandable, specific embodiments of the present application are specifically set forth below.

### BRIEF DESCRIPTION OF THE DRAWINGS

By referring to the following detailed description of the exemplary embodiments of the present application in conjunction with the accompanying drawings, the above and other objects, features, and advantages of the present application will become readily understandable. In the drawings, several embodiments of the present application are shown in an exemplary and non-limiting manner, and like or corresponding reference numerals designate like or corresponding parts, wherein:

FIG. 1 shows a flow chart of a method for detecting an acid-etching speed of core glass provided by an embodiment of the present application;

FIG. 2 shows a flow chart of another method for detecting an acid-etching speed of core glass provided by an embodiment of the present application;

FIG. 3 shows a block diagram of a composition of an apparatus for detecting an acid-etching speed of core glass provided by an embodiment of the present application; and

FIG. 4 shows a block diagram of a composition of another apparatus for detecting an acid-etching speed of core glass provided by an embodiment of the present application.

### DETAILED DESCRIPTION OF THE EMBODIMENTS

The exemplary embodiments of the present application will now be described in more details with reference to the accompanying drawings. While the drawings illustrate exemplary embodiments of the present application, it should be understood that the present application may be implemented in various forms and should not be limited by the embodiments set forth herein. Rather, these embodiments are provided to enable a more thorough understanding of the present application and to fully convey the scope of the present application to those skilled in the art.

Furthermore, the terms “first”, “second”, and similar terms used in the present application do not denote any order, quantity, or importance, but are merely used to distinguish different components.

It should be noted that unless otherwise specified, technical terms or scientific terms used in the present application shall have the ordinary meaning as understood by those skilled in the art to which the present application pertains.

At present, the weighing method is commonly used to detect the acid-etching speed of sample microchannel plate blanks. Specifically, the mass of a sample microchannel plate blank is first measured with an electronic balance. The sample microchannel plate blank is then immersed in an acid solution for a preset duration, after the sample microchannel plate blank is removed, the sample microchannel plate blank is reweighed with the electronic balance. Finally, the acid-etching speed of the sample microchannel plate blank is calculated based on the two measured masses, the preset duration, and the end-face area of the sample microchannel plate blank. However, when the electronic balance has low measurement accuracy or the detection personnel lacks work experience and operates improperly, the mass of the sample microchannel plate blank is not able to be accurately measured, which may lead to inaccurate detection of the acid-etching speed of the sample microchannel plate blank.

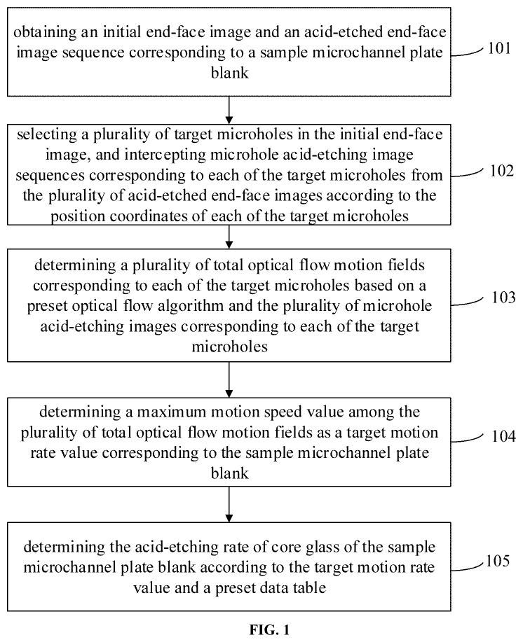

Therefore, in order to improve the accuracy of detecting the acid-etching speed of a sample microchannel plate blank, an embodiment of the present application provides a method for detecting an acid-etching speed of core glass. As shown in FIG. 1, the method at least includes steps 101 to 105.

101. Obtaining an initial end-face image and an acid-etched end-face image sequence corresponding to a sample microchannel plate blank.

Wherein, the initial end-face image is an image captured by an imaging device of a target area of the sample microchannel plate blank before acid-etching the target area with an acid solution, and the acid-etched end-face image sequence includes a plurality of acid-etched end-face images, the plurality of acid-etched end-face images being a plurality of consecutively captured images in shooting order by the imaging device of the target area after acid-etching the target area with the acid solution.

In the embodiments of the present application, the entity performing each of the steps is an acid-etching speed detection application executing on a target terminal device, wherein the target terminal device may include, but is not limited to, a computer, a tablet computer, a laptop computer, and the like.

After placing the sample microchannel plate blank on a stage, a detection worker captures an image of a target area of the sample microchannel plate blank through an imaging device to obtain an initial end-face image corresponding to the sample microchannel plate blank. After acid-etching the target area with an acid solution (i.e., dropping the acid solution onto the target area) and waiting for 10 seconds, the imaging device continuously captures the target area at a shooting time interval of 0.001 second to obtain a plurality of acid-etched end-face images corresponding to the sample microchannel plate blank, wherein the acid solution used may include, but is not limited to 65% concentration nitric acid. The imaging device is electrically connected to the target terminal device, and after capturing the initial end-face image and the plurality of acid-etched end-face images corresponding to the sample microchannel plate blank, the imaging device transmits the initial end-face image and the plurality of acid-etched end-face images to the target terminal device, the target terminal device may store the initial end-face image and the plurality of acid-etched end-face images corresponding to the sample microchannel plate blank in the local storage space. When detecting the acid-etching speed of the sample microchannel plate blank is required, the acid-etching speed detection application program retrieves the initial end-face image and the plurality of acid-etched end-face images corresponding to the sample microchannel plate blank from the local storage space of the target terminal device, and randomly selects N acid-etched end-face images that are consecutive in shooting order from the plurality of acid-etched end-face images to form an acid-etched end-face image sequence corresponding to the sample microchannel plate blank, where N may be, but is not limited to, 10, 15, 20, etc.

It should be noted that the optical flow algorithm is suitable for detecting sub-pixel level motion, and the detection effect is better when the motion distance of the same pixel point in two images is less than one pixel. When the shooting time interval is 0.001 second, the motion distance of the same pixel point in two adjacent acid-etched end-face images is between 10⁻² pixels and 10⁻⁵ pixels, thereby ensuring a better detection effect.

It should be noted that the imaging device includes an industrial camera and a microscope, and the magnification of the microscope may be, but is not limited to, 20×, 30×, 40×, 50×, etc. The camera chip size and pixel size of the industrial camera are determined according to the inner diameter of the microholes corresponding to the sample microchannel plate blank, the magnification of the microscope, and a preset rule. For example, the preset rule is: (1) the inner diameter of each microhole included in the sample microchannel plate blank should occupy at least 30 pixels in the end-face image; (2) the larger the field of view of the imaging device, the better; (3) the budget cost for the imaging device is A. If the magnification of the microscope is 20× and the inner diameter of the microholes corresponding to the sample microchannel plate blank is 6 micrometers, the size (side length) of each pixel in the end-face image should be less than 0.2 micrometers (6 micrometers divided by 30). Since the size (side length) of each pixel in the end-face image is equal to the pixel size of the industrial camera divided by the magnification, the pixel size of the industrial camera needs to be less than 4 micrometers. The field of view of the imaging device is equal to the camera chip size of the industrial camera divided by the magnification of the microscope. When the magnification of the microscope is fixed, the larger the camera chip size of the industrial camera, the larger the field of view of the imaging device. However, a larger camera chip size also results in a higher cost. Therefore, a larger camera chip size should be selected while ensuring that the budget cost of the imaging device is less than or equal to A.

102. Selecting a plurality of target microholes in the initial end-face image, and intercept, from the plurality of acid-etched end-face images according to the position coordinates corresponding to each target microhole, a microhole acid-etching image sequence corresponding to each target microhole.

Wherein, for any given target microhole, the position coordinates corresponding to the target microhole are used to indicate the position of the target microhole in the initial end-face image. Specifically, the position coordinates corresponding to the target microhole may be the position coordinates of the center of the target microhole in the initial end-face image. The microhole acid-etching image sequence corresponding to the target microhole includes a plurality of microhole acid-etching images corresponding to the target microhole.

Since the positions of certain microholes in the acid-etched end-face images are difficult to determine, and the position of the same microhole remains fixed in both the initial end-face image and each acid-etched end-face image, after obtaining the initial end-face image and the acid-etched end-face image sequence corresponding to the sample microchannel plate blank, the acid-etching speed detection application may select a plurality of target microchannels in the initial end-face image, determine the position coordinates of each target microhole in the initial end-face image, then locate each target microhole in each acid-etched end-face image based on its position coordinates in the initial end-face image, and intercept the corresponding microhole acid-etching image of each target microhole from each acid-etched end-face image to obtain a plurality of microhole acid-etching images corresponding to each target microhole, thereby forming the microhole acid-etching image sequence corresponding to each target microhole.

Wherein, for any target microhole, after locating the target microhole in a certain acid-etched end-face image according to its position coordinates in the initial end-face image, the microhole acid-etching image corresponding to the target microhole is intercepted with the circle center of the target microhole as the center, i.e., the center of the intercepted microhole acid-etching image is the circle center of the target microhole.

103. Determining a plurality of total optical flow motion fields corresponding to each of the target microholes based on a preset optical flow algorithm and the plurality of microhole acid-etching images corresponding to each of the target microholes.

Wherein, the preset optical flow algorithm may include, but is not limited to, the HS optical flow algorithm, the LK optical flow algorithm, the Brox optical flow algorithm, etc., and the embodiments of the present application do not specifically limit this.

Upon intercepting the microhole acid-etching image sequence corresponding to each target microhole, the acid-etching speed detection application may determine a plurality of total optical flow motion fields corresponding to each target microhole based on a preset optical flow algorithm and the plurality of microhole acid-etching images corresponding to each target microhole.

104. Determining a maximum motion speed value among the plurality of total optical flow motion fields as a target motion speed value corresponding to the sample microchannel plate blank.

After determining the plurality of total optical flow motion fields corresponding to each target microhole, the acid-etching speed detection application may determine the maximum motion speed value among the plurality of total optical flow motion fields as the target motion speed value corresponding to the sample microchannel plate blank.

105. Determining the acid-etching speed of core glass of the sample microchannel plate blank according to the target motion speed value and a preset data table.

Wherein, the preset data table includes a plurality of preset motion speed intervals and a core glass acid-etching speed corresponding to each preset motion speed interval. Experienced detection personnel pre-determine the core glass acid-etching rates for different batches of sample microchannel plate blanks by using high-precision electronic scales with high measurement accuracy, obtain the core glass acid-etching speed corresponding to each batch of sample microchannel plate blanks, detect the target motion speed values corresponding to different batches of sample microchannel plate blanks using the method described in steps 101-104 above, then perform statistical analysis of different target motion speed values corresponding to the same core glass acid-etching rate, and determine, based on the different target motion speed values corresponding to each core glass acid-etching rate, the motion speed interval corresponding to each core glass acid-etching rate, thereby obtaining a plurality of preset motion speed intervals and the core glass acid-etching speed corresponding to each preset motion speed interval, i.e., the preset data table.

After determining the target motion speed value corresponding to the sample microchannel plate blank, the acid-etching speed detection application may determine the acid-etching speed of core glass corresponding to the sample microchannel plate blank based on the target motion speed value corresponding to the sample microchannel plate blank and the preset data table.

The embodiments of the present application provide a method for detecting the acid-etching speed of core glass, the embodiments of the present application are able to achieve that: after a detection worker captures an initial end-face image and a plurality of acid-etched end-face images corresponding to a sample microchannel plate blank through an imaging device, and stores the initial end-face image and the plurality of acid-etched end-face images corresponding to the sample microchannel plate blank in a local storage space of a target terminal device, an acid-etching speed detection application program acquires, from the local storage space of the target terminal device, the initial end-face image and the plurality of acid-etched end-face images corresponding to the sample microchannel plate blank, and randomly selects N acid-etched end-face images with consecutive shooting sequences from the plurality of acid-etched end-face images to form an acid-etched end-face image sequence corresponding to the sample microchannel plate blank. Next, the acid-etching speed detection application program selects a plurality of target microholes in the initial end-face image, intercepts, according to the position coordinates corresponding to each target microhole, a microhole acid-etching image sequence corresponding to each target microhole from the plurality of acid-etched end-face images, determines, based on a preset optical flow algorithm and the plurality of microhole acid-etching images included in the microchannel acid-etching image sequence corresponding to each target microhole, a plurality of total optical flow motion fields corresponding to each target microhole, determines a maximum motion velocity value among the plurality of total optical flow motion fields as a target motion velocity value corresponding to the sample microchannel plate blank, and determines the acid-etching speed of core glass corresponding to the sample microchannel plate blank according to the target motion velocity value corresponding to the sample microchannel plate blank and a preset data table. Because in the present application, only the detection worker needs to capture, through an imaging device, the initial end-face image and the plurality of acid-etched end-face images corresponding to the sample microchannel plate blank, and the acid-etching speed detection application program is able to determine the acid-etching speed of core glass corresponding to the sample microchannel plate blank. The entire process does not require intervention by the detection worker and does not involve the use of an electronic balance, thereby ensuring the accuracy of detecting the acid-etching speed of the sample microchannel plate blank.

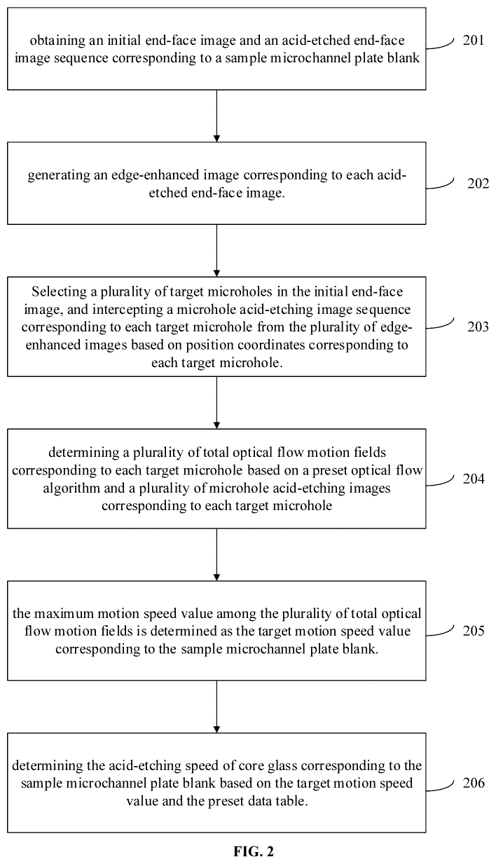

For a more detailed explanation, the embodiments of the present application provide another method for detecting the acid-etching speed of core glass, which is specifically shown in FIG. 2. The method includes at least steps 201 to 206.

201. Obtaining an initial end-face image and an acid-etched end-face image sequence corresponding to a sample microchannel plate blank.

Regarding step 201, obtaining the initial end-face image and the acid-etched end-face image sequence corresponding to the sample microchannel plate blank may refer to the description of the corresponding part in FIG. 1, and the embodiments of the present application will not repeat it here.

202. Generating an edge-enhanced image corresponding to each acid-etched end-face image.

After the acid-etching speed detection application program acquires the initial end-face image and the acid-etched end-face image sequence corresponding to the sample microchannel plate blank, it is necessary to perform noise reduction processing and edge enhancement processing on each acid-etched end-face image to generate an edge-enhanced image corresponding to each acid-etched end-face image. The specific process is as follows:

(1) Generating a target noise reduction matrix and a target edge enhancement matrix corresponding to the plurality of acid-etched end-face images.

First, based on the inner diameter of the microholes corresponding to the sample microchannel plate blank and the pixel size of the acid-etched end-face image, the number of pixels occupied by the inner diameter of the microholes is calculated. Specifically, the inner diameter of the microholes corresponding to the sample microchannel plate blank is divided by the pixel size (i.e., the side length of the pixel) of the acid-etched end-face image, and the calculation result is determined as the number of pixels occupied by the inner diameter of the microholes. Here, the number of pixels occupied by the inner diameter of the microholes refers to the number of pixels occupied by the inner diameter of the microholes in the acid-etched end-face image.

Second, generating a target noise reduction matrix based on the number of pixels occupied by the inner diameter of the microhole.

Wherein, when the number of pixels occupied by the inner diameter of the microholes is an odd number, the generated target noise reduction matrix is specifically:

$$\begin{matrix}nk & nk & nk & … & nk & nk & nk \\ & nk & & ⋮ & & nk & \\ nk & & n 3 & n 3 & n 3 & & nk \\ ⋮ & … & n 3 & n 1 & n 3 & … & ⋮ \\ nk & & n 3 & n 3 & n 3 & & nk \\ & nk & & ⋮ & & nk & \\ nk & nk & nk & … & nk & nk & nk\end{matrix}$$

Wherein, the target noise reduction matrix is a k*k matrix, with n1 as the center, a surrounding ring of elements around n1 are all n3, a surrounding ring around the plurality of n3 is n5 . . . the outermost ring of elements is nk, where k is the number of pixels occupied by the inner diameter of the microholes; wherein the sum of the plurality of elements included in the target noise reduction matrix equals 1.

Wherein, n1=2/(k+1),

$$n i = \frac{1}{2 ( k + 1 ) ( i - 1 )} , i = 3 , 5 , 7 … k .$$

Wherein, when the number of pixels occupied by the inner diameter of the microholes is an even number, the generated target noise reduction matrix is specifically:

$$\begin{matrix}nk & nk & nk & … & nk & nk & nk & \\ & nk & & ⋮ & & nk & & \\ nk & & n 4 & n 4 & n 4 & n 4 & nk & \\ ⋮ & … & n 4 & n 2 & n 2 & n 4 & … & ⋮ \\ & ⋮ & n 4 & n 2 & n 2 & n 4 & ⋮ & \\ & nk & n 4 & n 4 & n 4 & n 4 & nk & \\ & nk & & ⋮ & & nk & & \\ nk & nk & nk & … & nk & nk & nk & \end{matrix}$$

Wherein, the target noise reduction matrix is a k*k matrix, with a 2*2 matrix as the center, each element in the 2*2 matrix is n2, a surrounding ring of elements around the 2*2 matrix are all n4, a surrounding ring around the plurality of n4 elements is n6 . . . the outermost ring of elements is nk, where k is the number of pixels occupied by the inner diameter of the microholes; wherein the sum of the plurality of elements included in the target noise reduction matrix equals 1.

Wherein,

$$n i = \frac{1}{2 k ( i - 1 )} , i = 2 , 4 , 6 … k .$$

Finally, generating a target edge enhancement matrix based on the number of pixels occupied by the inner diameter of the microholes.

Wherein, when the number of pixels occupied by the inner diameter of the microholes is an odd number, the generated target edge enhancement matrix is specifically:

$$\begin{matrix}n 2 & n 2 & n 2 & … & n 2 & n 2 & n 2 \\ & n 2 & & ⋮ & & n 2 & \\ n 2 & & n 1 & n 1 & n 1 & & n 2 \\ ⋮ & … & n 1 & 1 & n 1 & … & ⋮ \\ n 2 & & n 1 & n 1 & n 1 & & n 2 \\ & n 2 & & ⋮ & & n 2 & \\ n 2 & n 2 & n 2 & … & n 2 & n 2 & n 2\end{matrix}$$

Wherein, the target edge enhancement matrix is a k*k matrix, the central element of the target edge enhancement matrix is 1, the outermost ring of elements is n2, and all remaining elements in the target edge enhancement matrix are n1; wherein the sum of the plurality of elements included in the target edge enhancement matrix equals 1.

Wherein,

$$n 1 = - \frac{1}{{k}^{2} - 4 k + 3} , n 2 = \frac{1}{4 k - 4} ,$$

wherein, k is the number of pixels occupied by the inner diameter of the microholes.

Wherein, when the number of pixels occupied by the inner diameter of the microholes is an even number, the generated target edge enhancement matrix is specifically:

$$\begin{matrix}n 4 & n 4 & n 4 & … & n 4 & n 4 & n 4 & \\ & n 4 & & ⋮ & & n 4 & & \\ & n 4 & n 3 & n 3 & n 3 & n 3 & n 4 & \\ ⋮ & … & n 3 & 1 / 4 & 1 / 4 & n 3 & … & ⋮ \\ & ⋮ & n 3 & 1 / 4 & 1 / 4 & n 3 & ⋮ & \\ & n 4 & n 3 & n 3 & n 3 & n 3 & n 4 & \\ & n 4 & & ⋮ & & n 4 & & \\ n 4 & n 4 & n 4 & … & n 4 & n 4 & n 4 & \end{matrix}$$

Wherein, the target edge enhancement matrix is a k*k matrix, with a 2*2 matrix as the center, each element in the 2*2 matrix is ¼, the outermost ring of elements is n4, and all remaining elements in the target edge enhancement matrix are n3; wherein the sum of the plurality of elements included in the target edge enhancement matrix equals 1.

Wherein,

$$n 3 = - \frac{1}{{k}^{2} - 4 k} , n 4 = \frac{1}{4 k - 4} ,$$

wherein, k is the number of pixels occupied by the inner diameter of the microholes.

(2) Performing convolution processing on each acid-etched end-face image using the target noise reduction matrix to obtain a noise-reduced image corresponding to each acid-etched end-face image.

Wherein, the type of convolution operation may specifically be a same convolution operation, that is, for any acid-etched end-face image, performing a same convolution operation on the acid-etched end-face image using the target noise reduction matrix to obtain the noise-reduced image corresponding to the acid-etched end-face image.

Wherein, performing convolution processing on the acid-etched end-face image using the target noise reduction matrix is capable of suppressing noise points in the acid-etched end-face image.

(3) Performing convolution processing on each noise-reduced image using the target edge enhancement matrix to obtain an edge-enhanced image corresponding to each acid-etched end-face image.

Wherein, the type of convolution operation may specifically be a same convolution operation, that is, for any noise-reduced image, performing a same convolution operation on the noise-reduced image using the target edge enhancement matrix to obtain the edge-enhanced image corresponding to the noise-reduced image.

Wherein, performing convolution processing on the noise-reduced image using the target edge enhancement matrix enables effective control of the blurring phenomenon of microhole boundaries caused by acid etching.

203. Selecting a plurality of target microholes in the initial end-face image, and intercepting a microhole acid-etching image sequence corresponding to each target microhole from the plurality of edge-enhanced images based on position coordinates corresponding to each target microhole.

Wherein, regarding step 203, selecting a plurality of target microholes in the initial end-face image and intercepting a microhole acid-etching image sequence corresponding to each target microhole from the plurality of edge-enhanced images based on the position coordinates corresponding to each target microhole may refer to the relevant description of step 102 above, and the embodiments of the present application will not repeat it here.

204. Determining a plurality of total optical flow motion fields corresponding to each target microhole based on a preset optical flow algorithm and a plurality of microhole acid-etching images corresponding to each target microhole.

After the acid-etching speed detection application intercepts the microhole acid etching image sequence corresponding to each target microhole, it may determine a plurality of total optical flow motion fields corresponding to each target microhole based on a preset optical flow algorithm and the plurality of microhole acid etching images corresponding to each target microhole. The following will describe in detail how the acid-etching speed detection application determines the plurality of total optical flow motion fields corresponding to each target microhole based on the preset optical flow algorithm and the plurality of microhole acid etching images corresponding to each target microhole:

For any target microhole, first, grouping the plurality of microhole acid-etching images according to the shooting sequence of each microhole acid-etching image corresponding to the target microhole to obtain a plurality of image groups, wherein for any microhole acid-etching image, the shooting sequence corresponding to the microhole acid-etching image is the shooting sequence corresponding to the acid-etched end-face image to which the microhole acid-etching image belongs, and each image group includes two microhole acid-etching images with adjacent shooting sequences; second, extracting a horizontal optical flow motion field and a vertical optical flow motion field corresponding to each image group based on the preset optical flow algorithm; and finally, performing merging processing on the horizontal optical flow motion field and the vertical optical flow motion field corresponding to each image group to obtain the plurality of total optical flow motion fields corresponding to the target microhole.

Wherein, the specific process of extracting the horizontal optical flow motion field and the vertical optical flow motion field corresponding to each image group based on the preset optical flow algorithm is: first, acquiring a preset limitation condition; second, extracting the horizontal optical flow motion field and the vertical optical flow motion field corresponding to each image group based on the preset optical flow algorithm and the preset limitation condition. The preset limitation condition is defined as: drawing a circle with the center of the microhole acid-etching image as the center and with the number of pixels occupied by the inner diameter of the microholes corresponding to the sample microchannel plate blank as the diameter, defining the area inside the circle as a first area and the area outside the circle as a second area, and requiring that the image gradient change between the pixel points at the edge position of the first area and the pixel points at the edge position of the second area is maximized.

205. The maximum motion speed value among the plurality of total optical flow motion fields is determined as the target motion speed value corresponding to the sample microchannel plate blank.

Wherein, regarding step 205, determining the maximum motion speed value among the plurality of total optical flow motion fields as the target motion speed value corresponding to the sample microchannel plate blank may refer to the description of the corresponding part in FIG. 1, and the embodiments of the present application will not repeat it here.

206. Determining the acid-etching speed of core glass corresponding to the sample microchannel plate blank based on the target motion speed value and the preset data table.

After the acid-etching speed detection application determines the target motion speed value corresponding to the sample microchannel plate blank, it may determine the acid-etching speed of core glass corresponding to the sample microchannel plate blank based on the target motion speed value corresponding to the sample microchannel plate blank and the preset data table.

Specifically, in this step, the specific process by which the acid-etching speed detection application determines the acid-etching speed of core glass corresponding to the sample microchannel plate blank based on the target motion speed value and the preset data table is:
First, matching the target motion speed value with a plurality of preset motion speed intervals; second, determining the acid-etching speed of core glass corresponding to the successfully matched preset motion speed interval as the acid-etching speed of core glass corresponding to the sample microchannel plate blank.

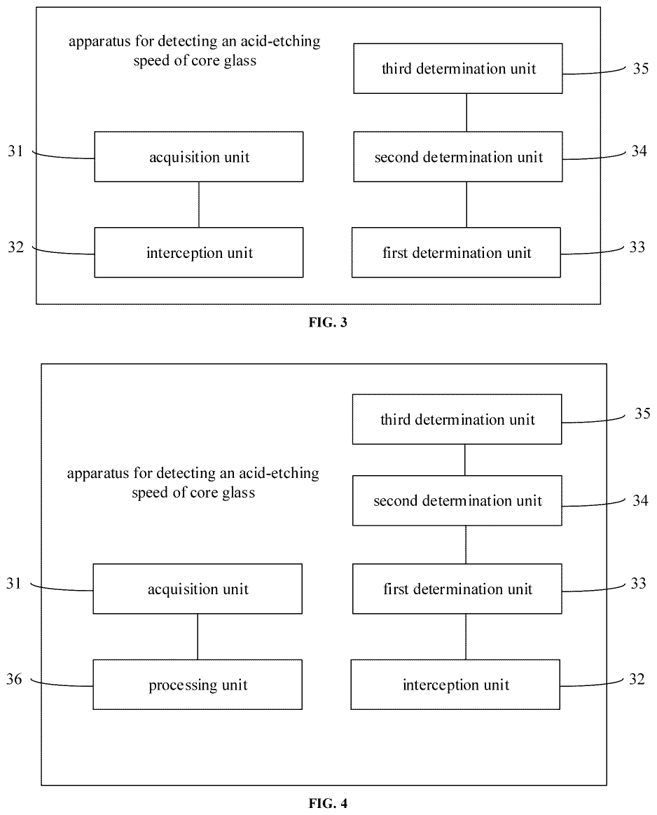

Further, as an implementation of the methods shown in FIG. 1 and FIG. 2, another embodiment of the present application further provides an apparatus for detecting an acid-etching speed of core glass. This apparatus embodiment corresponds to the foregoing method embodiments. For ease of reading, details in the foregoing method embodiments are not described again in this apparatus embodiment, but it should be clear that the apparatus in this embodiment is capable of correspondingly implement all the content in the foregoing method embodiments. The apparatus is applied to improving the accuracy of detecting the acid-etching speed of a sample microchannel plate blank, and specifically as shown in FIG. 3, the apparatus includes:

An acquisition unit 31, configured to obtain an initial end-face image and an acid-etched end-face image sequence corresponding to a sample microchannel plate blank, wherein the initial end-face image is an image obtained by photographing a target area of the sample microchannel plate blank with a photographing device before acid-etching the target area with an acid solution, the acid-etched end-face image sequence includes a plurality of acid-etched end-face images, and the plurality of acid-etched end-face images are a plurality of consecutively photographed images obtained by photographing the target area with the photographing device after acid-etching the target area with the acid solution.

An interception unit 32, configured to select a plurality of target microholes in the initial end-face image, and intercepting microhole acid-etching image sequences corresponding to each of the target microholes from the plurality of acid-etched end-face images according to the position coordinates of each of the target microholes, wherein the position coordinates of the target microholes indicate the positions of the target microholes in the initial end-face image, and the microhole acid-etching image sequences corresponding to the target microholes include a plurality of microhole acid-etching images of the target microholes.

A first determination unit 33, configured to determine a plurality of total optical flow motion fields corresponding to each of the target microholes based on a preset optical flow algorithm and the plurality of microhole acid-etching images corresponding to each of the target microholes;

A second determination unit 34, configured to determine a maximum motion speed value among the plurality of total optical flow motion fields as a target motion speed value corresponding to the sample microchannel plate blank.

A third determination unit 35, configured to determine the acid-etching speed of core glass of the sample microchannel plate blank according to the target motion speed value and a preset data table, wherein the preset data table includes a plurality of preset motion speed intervals and the acid-etching speed of core glass corresponding to each of the preset motion speed intervals.

Further, as shown in FIG. 4, the apparatus further includes:

A processing unit 36, configured to generate, after the acquisition unit 31 acquires the initial end-face image and the acid-etched end-face image sequence corresponding to the sample microchannel plate blank, a target noise reduction matrix and a target edge enhancement matrix corresponding to the plurality of acid-etched end-face images; perform convolution processing on each of the acid-etched end-face images using the target noise reduction matrix to obtain a noise-reduced image corresponding to each of the acid-etched end-face images; perform convolution processing on each of the noise-reduced images using the target edge enhancement matrix to obtain an edge-enhanced image corresponding to each of the acid-etched end-face images.

The interception unit 32, specifically configured to intercept, from the plurality of edge-enhanced images, a microhole acid-etching image sequence corresponding to each of the target microholes based on the position coordinates corresponding to each of the target microholes.

Further, as shown in FIG. 4, the processing unit 36 is specifically configured to: calculate the number of pixels occupied by the inner diameter of the microholes corresponding to the sample microchannel plate blank according to the inner diameter of the microholes corresponding to the sample microchannel plate blank and the pixel size corresponding to the acid-etched end-face image; generate the target noise reduction matrix according to the number of pixels occupied by the inner diameter of the microholes; and generate the target edge enhancement matrix according to the number of pixels occupied by the inner diameter of the microholes.

Further, as shown in FIG. 4, the first determination unit 33 is specifically configured to: perform grouping processing on the plurality of microhole acid-etching images according to the photographing sequence of each microhole acid-etching image corresponding to the target microhole to obtain a plurality of image groups, wherein each image group includes two microhole acid-etching images with adjacent photographing sequences; extract a horizontal optical flow motion field and a vertical optical flow motion field corresponding to each image group based on the preset optical flow algorithm; and perform merging processing on the horizontal optical flow motion field and the vertical optical flow motion field corresponding to each image group to obtain the plurality of total optical flow motion fields corresponding to the target microhole.

Further, as shown in FIG. 4, the first determination unit 33 is specifically configured to: acquire a preset limitation condition; and extract a horizontal optical flow motion field and a vertical optical flow motion field corresponding to each image group based on the preset optical flow algorithm and the preset limitation condition.

Further, as shown in FIG. 4, the preset limitation condition is defined as: drawing a circle with the center of the microhole acid-etching image as the circle center and with the number of pixels occupied by the inner diameter of the microholes corresponding to the sample microchannel plate blank as the diameter, defining the area inside the circle as a first area and the area outside the circle as a second area, and requiring that the image gradient change between the pixel points at the edge position of the first area and the pixel points at the edge position of the second area is maximized.

Further, as shown in FIG. 4, the third determination unit 35 is specifically configured to: match the target motion speed value with the plurality of preset motion speed intervals; and determine the acid-etching speed of core glass corresponding to the successfully matched preset motion speed interval as the acid-etching speed core glass corresponding to the sample microchannel plate blank.

The embodiments of the present application provide a method and apparatus for detecting the acid-etching speed of core glass, the embodiments of the present application are able to achieve that: after a detection worker captures an initial end-face image and a plurality of acid-etched end-face images corresponding to a sample microchannel plate blank through an imaging device, and stores the initial end-face image and the plurality of acid-etched end-face images corresponding to the sample microchannel plate blank in a local storage space of a target terminal device, an acid-etching speed detection application program acquires, from the local storage space of the target terminal device, the initial end-face image and the plurality of acid-etched end-face images corresponding to the sample microchannel plate blank, and randomly selects N acid-etched end-face images with consecutive shooting sequences from the plurality of acid-etched end-face images to form an acid-etched end-face image sequence corresponding to the sample microchannel plate blank. Next, the acid-etching speed detection application program selects a plurality of target microholes in the initial end-face image, intercepts, according to the position coordinates corresponding to each target microhole, a microhole acid-etching image sequence corresponding to each target microhole from the plurality of acid-etched end-face images, determines, based on a preset optical flow algorithm and the plurality of microhole acid-etching images included in the microchannel acid-etching image sequence corresponding to each target microhole, a plurality of total optical flow motion fields corresponding to each target microhole, determines a maximum motion velocity value among the plurality of total optical flow motion fields as a target motion velocity value corresponding to the sample microchannel plate blank, and determines the acid-etching speed of core glass corresponding to the sample microchannel plate blank according to the target motion velocity value corresponding to the sample microchannel plate blank and a preset data table. Because in the present application, only the detection worker needs to capture, through an imaging device, the initial end-face image and the plurality of acid-etched end-face images corresponding to the sample microchannel plate blank, and the acid-etching speed detection application program is able to determine the acid-etching speed of core glass corresponding to the sample microchannel plate blank. The entire process does not require intervention by the detection worker and does not involve the use of an electronic balance, thereby ensuring the accuracy of detecting the acid-etching speed of the sample microchannel plate blank.

An embodiment of the present application provides a storage medium including a stored program, wherein when the program runs, the program controls the apparatus on which the storage medium is located to execute the method for detecting the acid-etching speed of core glass described above.

The storage medium may include non-transitory memory in a computer-readable medium, in forms such as random access memory (RAM) and/or non-volatile memory, such as read-only memory (ROM) or flash RAM. The memory includes at least one memory chip.

An embodiment of the present application further provides an apparatus for detecting an acid-etching speed of core glass, the apparatus including a storage medium; and one or more processors, wherein the storage medium is coupled to the processors, and the processors are configured to execute program instructions stored in the storage medium; when the program instructions run, the method for detecting the acid-etching speed of core glass described above is executed.

An embodiment of the present application provides a device, the device including a processor, a memory, and a program stored on the memory and executable on the processor, wherein when the processor executes the program, the following steps are implemented:

Obtaining an initial end-face image and an acid-etched end-face image sequence corresponding to a sample microchannel plate blank, wherein the initial end-face image is an image obtained by photographing a target area of the sample microchannel plate blank with a photographing device before acid-etching the target area with an acid solution, the acid-etched end-face image sequence includes a plurality of acid-etched end-face images, and the plurality of acid-etched end-face images are a plurality of consecutively photographed images obtained by photographing the target area with the photographing device after acid-etching the target area with the acid solution.

Selecting a plurality of target microholes in the initial end-face image, and intercepting microhole acid-etching image sequences corresponding to each of the target microholes from the plurality of acid-etched end-face images according to the position coordinates of each of the target microholes, wherein the position coordinates of the target microholes indicate the positions of the target microholes in the initial end-face image, and the microhole acid-etching image sequences corresponding to the target microholes include a plurality of microhole acid-etching images of the target microholes.

Determining a plurality of total optical flow motion fields corresponding to each of the target microholes based on a preset optical flow algorithm and the plurality of microhole acid-etching images corresponding to each of the target microholes.

Determine a maximum motion speed value among the plurality of total optical flow motion fields as a target motion speed value corresponding to the sample microchannel plate blank.

Determine the acid-etching speed of core glass of the sample microchannel plate blank according to the target motion speed value and a preset data table, wherein the preset data table includes a plurality of preset motion speed intervals and the acid-etching speed of core glass corresponding to each of the preset motion speed intervals.

Further, after obtaining the initial end-face image and the acid-etched end-face image sequence corresponding to the sample microchannel plate blank, the method further includes:

Generating a target noise reduction matrix and a target edge enhancement matrix corresponding to the plurality of acid-etched end-face images.

Performing convolution processing on each of the acid-etched end-face images using the target noise reduction matrix to obtain a noise-reduced image corresponding to each of the acid-etched end-face images.

Performing convolution processing on each of the noise-reduced images using the target edge enhancement matrix to obtain an edge-enhanced image corresponding to each of the acid-etched end-face images.

Intercepting microhole acid-etching image sequences corresponding to each of the target microholes from the plurality of acid-etched end-face images according to the position coordinates of each of the target microholes includes:

Intercepting, from the plurality of edge-enhanced images, a microhole acid-etching image sequence corresponding to each of the target microholes based on the position coordinates corresponding to each of the target microholes.

Further, generating a target noise reduction matrix and a target edge enhancement matrix corresponding to the plurality of acid-etched end-face images includes:

Calculating the number of pixels occupied by the inner diameter of the microholes corresponding to the sample microchannel plate blank according to the inner diameter of the microholes corresponding to the sample microchannel plate blank and the pixel size corresponding to the acid-etched end-face image.

Generating the target noise reduction matrix according to the number of pixels occupied by the inner diameter of the microholes.

Generating the target edge enhancement matrix according to the number of pixels occupied by the inner diameter of the microholes.

Further, determining a plurality of total optical flow motion fields corresponding to each of the target microholes based on a preset optical flow algorithm and the plurality of microhole acid-etching images corresponding to each of the target microholes includes:

Performing grouping processing on the plurality of microhole acid-etching images according to the photographing sequence of each microhole acid-etching image corresponding to the target microhole to obtain a plurality of image groups, wherein each image group includes two microhole acid-etching images with adjacent photographing sequences.

Extracting a horizontal optical flow motion field and a vertical optical flow motion field corresponding to each image group based on the preset optical flow algorithm.

Perform merging processing on the horizontal optical flow motion field and the vertical optical flow motion field corresponding to each image group to obtain the plurality of total optical flow motion fields corresponding to the target microhole.

Further, extracting a horizontal optical flow motion field and a vertical optical flow motion field corresponding to each image group based on the preset optical flow algorithm includes:

Acquiring a preset limitation condition.

Extracting a horizontal optical flow motion field and a vertical optical flow motion field corresponding to each image group based on the preset optical flow algorithm and the preset limitation condition.

Further, the preset limitation condition is defined as: drawing a circle with the center of the microhole acid-etching image as the circle center and with the number of pixels occupied by the inner diameter of the microholes corresponding to the sample microchannel plate blank as the diameter, defining the area inside the circle as a first area and the area outside the circle as a second area, and requiring that the image gradient change between the pixel points at the edge position of the first area and the pixel points at the edge position of the second area is maximized.

Further, determining the acid-etching speed of core glass of the sample microchannel plate blank according to the target motion speed value and a preset data table includes:

Matching the target motion speed value with the plurality of preset motion speed intervals.

Determining the acid-etching speed of core glass corresponding to the successfully matched preset motion speed interval as the acid-etching speed core glass corresponding to the sample microchannel plate blank.

The present application further provides a computer program product, which when executed on a data processing device, is adapted to execute program code initialized with the following method steps: obtaining an initial end-face image and an acid-etched end-face image sequence corresponding to a sample microchannel plate blank, wherein the initial end-face image is an image obtained by photographing a target area of the sample microchannel plate blank with a photographing device before acid-etching the target area with an acid solution, the acid-etched end-face image sequence comprises a plurality of acid-etched end-face images, and the plurality of acid-etched end-face images are a plurality of consecutively photographed images obtained by photographing the target area with the photographing device after acid-etching the target area with the acid solution; selecting a plurality of target microholes in the initial end-face image, and intercepting microhole acid-etching image sequences corresponding to each of the target microholes from the plurality of acid-etched end-face images according to the position coordinates of each of the target microholes, wherein the position coordinates of the target microholes indicate the positions of the target microholes in the initial end-face image, and the microhole acid-etching image sequences corresponding to the target microholes comprise a plurality of microhole acid-etching images of the target microholes; determining a plurality of total optical flow motion fields corresponding to each of the target microholes based on a preset optical flow algorithm and the plurality of microhole acid-etching images corresponding to each of the target microholes; determining a maximum motion speed value among the plurality of total optical flow motion fields as a target motion speed value corresponding to the sample microchannel plate blank; and determining the acid-etching speed of core glass of the sample microchannel plate blank according to the target motion speed value and a preset data table, wherein the preset data table comprises a plurality of preset motion speed intervals and the acid-etching speed of core glass corresponding to each of the preset motion speed intervals.

Those skilled in the art should understand that the embodiments of the present application may be provided as a method, system, or computer program product. Therefore, the present application may employ the form of a complete hardware embodiment, a complete software embodiment, or an embodiment combining software and hardware aspects. Furthermore, the present application may take the form of a computer program product embodied on one or more computer-usable storage media (including but not limited to disk storage, CD-ROM, optical storage, etc.) that contain computer-usable program code.

The present application is described with reference to flowchart illustrations and/or block diagrams of methods, apparatus (systems), and computer program products according to embodiments of the present application. It should be understood that each flow and/or block in the flowchart illustrations and/or block diagrams, and combinations of flows and/or blocks in the flowchart illustrations and/or block diagrams, may be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in a flow or flows in the flowchart and/or a block or blocks in the block diagram.

These computer program instructions may also be stored in a computer-readable memory that may direct a computer or other programmable data processing apparatus to function in a particular manner, such that the instructions stored in the computer-readable memory produce an article of manufacture including instruction means which implement the function specified in a flow or flows in the flowchart and/or a block or blocks in the block diagram.

These computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in a flow or flows in the flowchart and/or a block or blocks in the block diagram.

In a typical configuration, a computing device includes one or more processors (CPUs), input/output interfaces, a network interface, and memory.

The memory may include non-transitory storage in computer-readable media, such as random access memory (RAM) and/or non-volatile memory in various forms, such as read-only memory (ROM) or flash RAM. The memory is an example of computer-readable media.

The computer-readable media includes both non-transitory and transitory, removable and non-removable media that may store information using any method or technology. Information may be computer-readable instructions, data structures, program modules or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc read-only memory (CD-ROM), digital versatile disc (DVD) or other optical storage, magnetic tape cartridges, magnetic disk storage or other magnetic storage devices or any other non-transmission medium that can store information accessible to computing devices. According to the definition in this article, the computer-readable media does not include transient media such as modulated data signals and carriers.

It should also be noted that the terms “including”, “comprising”, or any of their variations are intended to cover non-exclusive inclusion, thereby enabling a process, method, product or device that includes a series of elements to not only include those elements, but also to include other elements that are not explicitly listed, or to include elements inherent to such a process, method, product or device. Without further limitations, the elements limited by the statement “including one . . . ” do not exclude the existence of other identical elements in the process, method, product or device that includes those elements.

It should be understood by those skilled in the art that the embodiments of the present application may be implemented as methods, systems or computer program products. Therefore, the present application may take the form of a fully hardware implementation, a fully software implementation, or an implementation combining software and hardware aspects. Moreover, the present application may be implemented in the form of a computer program product that is executed on one or more computer-readable storage media (including but not limited to disk storage, CD-ROM, optical storage, etc.).

The above are merely examples of the implementation of the present application and do not limit the scope of the present application. For those skilled in the art, the present application may have various modifications and variations. Any changes, equivalents, improvements, etc. made within the spirit and principles of this application shall be included within the scope of the claims of the present application.

1. A method for detecting an acid-etching speed of core glass, comprising:
obtaining an initial end-face image and an acid-etched end-face image sequence corresponding to a sample microchannel plate blank, wherein the initial end-face image is an image obtained by photographing a target area of the sample microchannel plate blank with a photographing device before acid-etching the target area with an acid solution, the acid-etched end-face image sequence comprises a plurality of acid-etched end-face images, and the plurality of acid-etched end-face images are a plurality of consecutively photographed images obtained by photographing the target area with the photographing device after acid-etching the target area with the acid solution;
selecting a plurality of target microholes in the initial end-face image, and intercepting microhole acid-etching image sequences corresponding to each of the target microholes from the plurality of acid-etched end-face images according to the position coordinates of each of the target microholes, wherein the position coordinates of the target microholes indicate the positions of the target microholes in the initial end-face image, and the microhole acid-etching image sequences corresponding to the target microholes comprise a plurality of microhole acid-etching images of the target microholes;
determining a plurality of total optical flow motion fields corresponding to each of the target microholes based on a preset optical flow algorithm and the plurality of microhole acid-etching images corresponding to each of the target microholes;
determining a maximum motion speed value among the plurality of total optical flow motion fields as a target motion speed value corresponding to the sample microchannel plate blank; and
determining the acid-etching speed of core glass of the sample microchannel plate blank according to the target motion speed value and a preset data table, wherein the preset data table comprises a plurality of preset motion speed intervals and the acid-etching speed of core glass corresponding to each of the preset motion speed intervals.

2. The method according to claim 1, wherein after obtaining the initial end-face image and the acid-etched end-face image sequence corresponding to the sample microchannel plate blank, the method further comprises:
generating a target noise reduction matrix and a target edge enhancement matrix corresponding to the plurality of acid-etched end-face images;
performing convolution operation processing on each of the acid-etched end-face images with the target noise reduction matrix to obtain noise-reduced images corresponding to each of the acid-etched end-face images;
performing convolution operation processing on each of the noise-reduced images with the target edge enhancement matrix to obtain edge-enhanced images corresponding to each of the acid-etched end-face images; and
the step of intercepting the microhole acid-etching image sequence corresponding to each of the target microholes from the plurality of acid-etched end-face images according to the position coordinates of each of the target microholes comprises:
intercepting the microhole acid-etching image sequences corresponding to each of the target microholes from the plurality of edge-enhanced images according to the position coordinates of each of the target microholes.

3. The method according to claim 2, wherein generating the target noise reduction matrix and the target edge enhancement matrix corresponding to the plurality of acid-etched end-face images comprises:
calculating a number of pixel points occupied by inner diameters of microholes based on the inner diameters of the microholes corresponding to the sample microchannel plate blank and pixel sizes of the acid-etched end-face images;
generating the target noise reduction matrix based on the number of pixel points occupied by the inner diameters of the microholes; and
generating the target edge enhancement matrix based on the number of pixel points occupied by the inner diameter of the microholes.

4. The method according to claim 1, wherein determining the plurality of total optical flow motion fields corresponding to each of the target microholes based on the preset optical flow algorithm and the plurality of microhole acid-etching images corresponding to each of the target microholes comprises:
performing grouping processing on the plurality of microhole acid-etching images according to the shooting sequence of each of the microhole acid-etching image corresponding to the target microholes to obtain a plurality of image groups, wherein each of the image groups comprises two adjacent microhole acid-etching images in the shooting sequence;
extracting a horizontal optical flow motion field and a vertical optical flow motion field corresponding to each of the image groups based on the preset optical flow algorithm; and
merging the horizontal optical flow motion field and the vertical optical flow motion field corresponding to each of the image groups to obtain the plurality of total optical flow motion fields corresponding to the target microholes.

5. The method according to claim 4, wherein extracting the horizontal optical flow motion field and the vertical optical flow motion field corresponding to each of the image groups based on the preset optical flow algorithm comprises:
obtaining a preset limitation condition; and
extracting the horizontal optical flow motion field and the vertical optical flow motion field corresponding to each of the image groups based on the preset optical flow algorithm and the preset limitation condition.

6. The method according to claim 5, wherein the preset limitation condition is: taking a center of the microhole acid-etching image as a circle centers, drawing a circle with the number of pixel points occupied by the inner diameters of the microholes corresponding to the sample microchannel plate blank as a diameter, designating an area inside the circle as a first area and an area outside the circle as a second area, and requiring that an image gradient change between the pixel points at an edge of the first area and the pixel points at an edge of the second area is maximized.

7. The method according to claim 1, wherein determining the acid-etching speed of core glass of the sample microchannel plate blank according to the target motion speed value and the preset data table comprises:
matching the target motion speed value with the plurality of preset motion speed intervals; and
determining the acid-etching speed of core glass corresponding to the preset motion speed intervals with successful matching as the acid-etching speed of core glass of the sample microchannel plate blank.

8. An apparatus for detecting the acid-etching speed of core glass, comprising:
an acquisition unit, configured to obtain an initial end-face image and an acid-etched end-face image sequence corresponding to a sample microchannel plate blank, wherein the initial end-face image is an image obtained by photographing a target area of the sample microchannel plate blank with a photographing device before acid-etching the target area with an acid solution, the acid-etched end-face image sequence comprises a plurality of acid-etched end-face images, and the plurality of acid-etched end-face images are a plurality of consecutively photographed images obtained by photographing the target area with the photographing device after acid-etching the target area with the acid solution;
an interception unit, configured to select a plurality of target microholes in the initial end-face image, and intercepting microhole acid-etching image sequences corresponding to each of the target microholes from the plurality of acid-etched end-face images according to the position coordinates of each of the target microholes, wherein the position coordinates of the target microholes indicate the positions of the target microholes in the initial end-face image, and the microhole acid-etching image sequences corresponding to the target microholes comprise a plurality of microhole acid-etching images of the target microholes;
a first determination unit, configured to determine a plurality of total optical flow motion fields corresponding to each of the target microholes based on a preset optical flow algorithm and the plurality of microhole acid-etching images corresponding to each of the target microholes;
a second determination unit, configured to determine a maximum motion speed value among the plurality of total optical flow motion fields as a target motion speed value corresponding to the sample microchannel plate blank; and
a third determination unit, configured to determine the acid-etching speed of core glass of the sample microchannel plate blank according to the target motion speed value and a preset data table, wherein the preset data table comprises a plurality of preset motion speed intervals and the acid-etching speed of core glass corresponding to each of the preset motion speed intervals.

9. A storage medium, comprising a stored program, wherein when the program runs, the program controls the apparatus on which the storage medium is located to execute the method for detecting the acid-etching speed of core glass as claimed in claim 1.

10. A device for detecting the acid-etching speed of core glass, comprising a storage medium; and one or more processors, wherein the storage medium is coupled to the processors, and the processors are configured to execute program instructions stored in the storage medium; when the program instructions run, the method for detecting the acid-etching speed of core glass according to claim 1 is executed.
